(19) United States
(12) Patent Application Publication
(10) Pub. No.: US 2021/0164676 A1
(43) Pub. Date: Jun. 3, 2021

(54) SYSTEMS AND METHODS FOR CONTROLLING AN AIR-CONDITIONING SYSTEM BASED ON GAIT RECOGNITION

(71) Applicant: WATRIX TECHNOLOGY CORPORATION LIMITED, Beijing (CN)

(72) Inventors: Yongzhen HUANG, Beijing (CN); Daoliang TAN, Beijing (CN); Yuqi ZHANG, Beijing (CN)

(73) Assignee: WATRIX TECHNOLOGY CORPORATION LIMITED, Beijing (CN)

(21) Appl. No.: 16/769,590

(22) PCT Filed: Dec. 20, 2018
(86) PCT No.: PCT/CN2018/122381

§ 371 Date: Jun. 4, 2020

(30) Foreign Application Priority Data
Dec. 22, 2017 (CN) 201711405468.9

(51) Int. Cl. F24F 11/30; F24F 11/56; F24F 11/80; F24F 11/64; F24F 11/65; F24F 11/89; G05B 13/04

(52) U.S. Cl. CPC F24F 11/30; F24F 11/56; F24F 11/80; F24F 2120/00; F24F 11/65; F24F 11/89; G05B 13/048; F24F 11/64

(57) ABSTRACT

Systems and methods for controlling an air-conditioning system based on gait recognition. The system includes a communication interface configured to receive sensor data captured of a scene by a sensor. The system further includes a storage configured to store the sensor data and a profile of registered users. The system also includes at least one processor. The at least one processor is configured to identify a human object within the sensor data. The processor is further configured to recognize gait features of the identified human object. The processor is also configured to generate a first instruction controlling the air-conditioning system based on the recognized gait features.

### CROSS-REFERENCE TO RELATED APPLICATIONS

This application is the national phase entry of International Application No. PCT/CN2018/122381, filed on Dec. 20, 2018, which is based upon and claims priority to Chinese Patent Application No. 201711405468.9, filed on Dec. 22, 2017, the entire contents of which are incorporated herein by reference.

### TECHNICAL FIELD

The present disclosure relates to systems and methods for controlling an air-conditioning system, and more particularly to, systems and methods for controlling an air-conditioning system based on gait recognition using sensor data.

### BACKGROUND

Smart air-conditioning system controlling relies heavily on accurately understanding a user's preference and personalize the control based on such preference. For example, a smart air-conditioning system may use the user's preference to choose operation mode, control temperature and moisture etc. Existing air-conditioning systems are controlled by the user manually inputting parameters reflecting the user's preference such as operation mode and temperature to the system, and the system then monitors the parameters and modifies the air condition by comparing the monitored parameters with the input ones. The air-conditioning system will adjust its operation to reduce the difference between the monitored parameters and the input ones.

The existing air-conditioning system controlling methods burden a user by requesting frequent interactions. In addition, for users who cannot provide manual inputs that reflect the user's preference precisely, the control method may fail. For example, a child may not know the exact room temperature that suits him or her the best.

Embodiments of the disclosure address the above problems by improved systems and methods for controlling an air-conditioning system based on gait recognition using sensor data.

### SUMMARY

Embodiments of the disclosure provide a method for controlling an air-conditioning system based on gait recognition. The method includes receiving sensor data captured of a scene by a sensor. The method further includes identifying, by at least one processor, a human object within the sensor data. The method further includes recognizing gait features of the identified human object. The method also includes generating a first instruction controlling the air-conditioning system based on the recognized gait features.

Embodiments of the disclosure also provide a system for controlling an air-conditioning system based on gait recognition. The system includes a communication interface configured to receive sensor data captured of a scene by a sensor. The system further includes a storage configured to store the sensor data and a profile of registered users. The system also includes at least one processor. The at least one processor is configured to identify a human object within the sensor data. The at least one processor is further configured to recognize gait features of the identified human object. The at least one processor is also configured to generate a first instruction controlling the air-conditioning system based on the recognized gait features.

Embodiments of the disclosure further provide a non-transitory computer-readable medium having instructions stored thereon that, when executed by one or more processors, causes the one or more processors to perform a method for controlling an air-conditioning system based on gait recognition. The method includes receiving sensor data captured of a scene by a sensor. The method further includes identifying a human object within the sensor data. The method further includes recognizing gait features of the identified human object. The method also includes generating a first instruction controlling the air-conditioning system based on the recognized gait features.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary air-conditioning controlling system, according to embodiments of the disclosure.

FIG. 2 illustrates a block diagram of an exemplary controlling server for controlling the air-conditioning system based on gait recognition, according to embodiments of the disclosure.

FIG. 3 illustrates a flowchart of an exemplary method for controlling the air-conditioning system based on gait recognition, according to embodiments of the disclosure.

FIG. 4 illustrates a flowchart of another exemplary method for controlling the air-conditioning system based on gait recognition, according to embodiments of the disclosure.

### DETAILED DESCRIPTION OF THE EMBODIMENTS

Reference will now be made in detail to the exemplary embodiments, examples of which are illustrated in the accompanying drawings. Wherever possible, the same reference numbers will be used throughout the drawings to refer to the same or like parts.

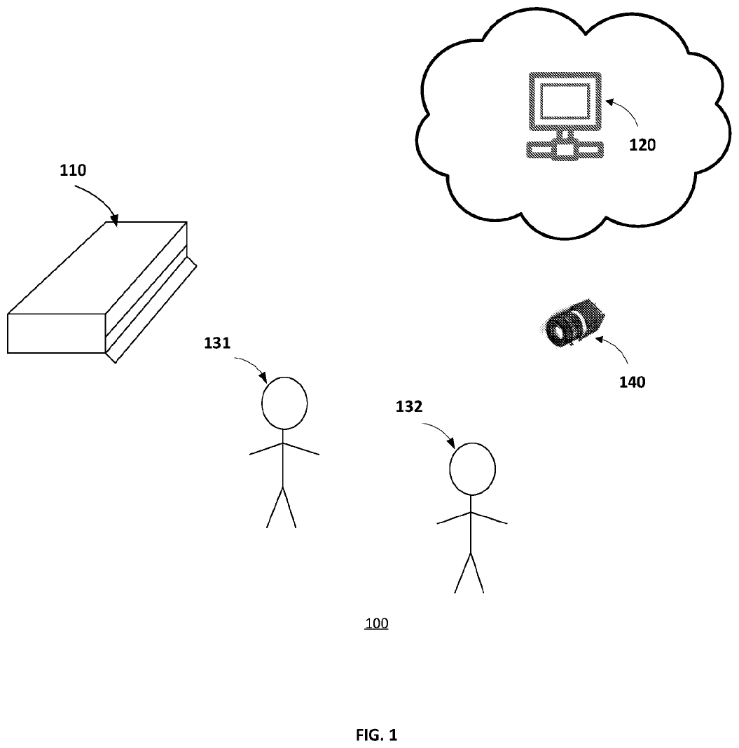

FIG. 1 illustrates a schematic diagram of an exemplary air-conditioning controlling system 100, according to embodiments of the disclosure. For example, air-conditioning controlling system 100 may be configured to control an air-condition system 110 based on gait recognition of users 131 and 132 using sensor data acquired by a sensor 140. Consistent with some embodiments, air-conditioning system 110 may be an air-conditioner configured to improve the comfort of occupants by modifying the condition of the air such as temperature, humidity and/or air circulation of the interior of an occupied space. For example, air-conditioning system 110 may be a central air conditioning, a room air conditioner, a ductless mini-split air conditioner, an evaporative cooler, a window air conditioner, a portable air conditioner, a hybrid air conditioner, or a geothermal heating and cooling air conditioner. Air conditioning system 110 may be installed in any occupied space such as a building or a car. In some embodiments, air-conditioning system 110 may include an evaporator, a compressor, a fan and a condenser. However, it is contemplated that air-conditioning system 110 may have other components or have equivalent structures that enable air-conditioning system 110 to modify the condition of air.

As illustrated in FIG. 1, sensor 140 may be devices configured to capture data. For example, sensor 140 may be a camera, a video camera, or another cost-effective imaging device or filming device. In some embodiments, sensor 140 may be static, such as a surveillance camera installed on an inner side of a wall of a structure, such that the devices may capture a view covering the interior space of the structure. The structure may be any structure that need air condition modification (e.g., an office, a warehouse or a living room). Otherwise, sensor 140 may be part of a mobile surveillance device such as a rotating camera, a surveillance drone, etc. Sensor 140 may be operated by an operator on-site, controlled remotely, and/or autonomous.

In some embodiments, sensor 140 may acquire images of the interior space of the structure (e.g., a living room within a residential house). The captured images may then be provided to a controlling server 120. In some embodiments, the captured images may be transmitted to controlling server 120 in real-time (e.g., by streaming), or collectively after a certain period of time (e.g., transmit images for every 5 seconds).

Upon receiving the images controlling server 120 may initiate an instruction generating process. In some embodiments, controlling server 120 may identify human objects 131 and 132 within the scene using any suitable identification methods. For example, controlling server 120 may identify human objects (corresponding to users 131 and 132) within the images based on background generation methods. For example, controlling server 120 may use a background generation method to identify human objects within the scene based on foreground detections, moving objects extractions, moving objects features extractions and moving object characterizations. For another example, machine learning methods may be applied to identify human objects. For example, a neural network (e.g., a convolutional neural network) may be pretrained using training sets (e.g., images having identified human objects) to process the images and to identify the human objects within the images.

In some embodiments, controlling server 120 may further recognize gait features of each human object. For example, controlling server 120 may extract a sequence of frames (e.g., multiple images taken in a certain period of time) in which the human object is moving, and recognize the gait feature of the human object based on the extracted sequence of frames using any suitable methods. For example, controlling server 120 may use model-based gait feature extraction methods (e.g., methods based on activity specific static body parameters or methods based on thigh joint trajectories) where the human body structures or motions are modeled, or any suitable model-free methods (e.g., methods based on template matching of body silhouettes in key frames during a human's walking cycle) where the entire human body motion is distinguished using a concise representation without considering the underlying body structure. Controlling server 120 may also use Hough Transformation-based gait recognition methods, Particle Filter based gait recognition methods and gait recognition methods based on support vector machines to recognize gait features of the human objects. In some embodiments, the recognized gait features include at least one of the human objects' ages, location, velocity and pose information.

In some embodiments, controlling server 120 may generate a first instruction including at least one of a target temperature, a target humidity, a target air flow volume and a target air flow direction based on the recognized gait features. For example, controlling server 120 may determine that one of the human objects identified within the scene is lying down in a location. In that case, controlling server 120 may choose to modify the air flow to avoid blowing directly to the location and increase the target temperature to a level suitable for sleeping.

In some embodiments, controlling server 120 may compare the recognized gait features with registered users' gait features. Based on the comparison, controlling server 120 may identify that the human object corresponds to one of the registered users and generate a second instruction modifying the condition of the air based on the pre-set profile of the registered user. For example, controlling server 120 may store preferences and gait features of different users, e.g., members of a family (referred to as “registered user's gait features”), and matching the recognized gait features with the registered user's gait features (e.g., matching with the gait features of the family members respectively). If the identified human figure is determined to be one of the registered users (e.g., the recognized gait feature matched with the father's gait features), controlling server 120 may generate the second instruction controlling the air-conditioning system according to the registered user's profile (e.g., the father's pre-set preference such as target temperatures, target humidity, etc.).

In some embodiments, controlling server 120 may generate a third instruction based on the first and second instructions to control the air-conditioning system. For example, controlling server 120 may prioritize different instructions based on the operation mode the instruction corresponds to. For example, controlling server 120 may generate a first instruction suitable for sleeping based on identifying a sleeping human object within the scene. Controlling server 120 may also generate a second instruction not suitable for sleeping based on an identified registered user's profile. In some embodiments, controlling server 120 may generate a third instruction based on the first and second instructions by giving the first instruction a heavier weight (e.g., 60% weight) and the second instruction a lesser weight (e.g., 40% weight).

In some other embodiments, controlling server 120 may further recognize facial features of the human objects based on the images captured by sensor 140. For example, controlling server 120 may use any suitable facial recognition methods such as any one of the Active Shape Model (ASM), the Eigenface algorithm, the Convolutional Neural Network (CNN), etc. to identify the registered user. In some embodiments, controlling server 120 may compare the recognized gait features and the recognized facial features with the registered users' gait features and facial features.

Based on the comparison, controlling server 120 may identify that the human object corresponds to one of the registered users, e.g., users 131, and generate a second instruction modifying the condition of the air based on the pre-set profile of the registered user. For example, controlling server 120 may generate a first prediction of an identity of the human object based on a face recognition model (similar to the gait recognition model described above), and may also generate a second prediction of the identity of the identified human object based on a gait recognition model (described above). Controlling server 120 may further identify the identity of the human object based on a probability determined by the first prediction, a weight of the first prediction, a probability determined by the second prediction, and a weight of the second prediction. For example, the weight may be pre-determined based on the precision of the face recognition model and the gait recognition model (e.g., the more reliable the recognition model is, the heavier weight the recognition model will be assigned to).

In some embodiments, if more than one registered user is identified by controlling server 120, controlling server 120 may generate the controlling instruction based on prioritizing the registers' preferences (e.g., give the older user a higher priority than the younger user), or weighting the registers' preference (give the older user more weight than the younger user).

As described above, the disclosed systems and methods provide improved controlling and reduced user interaction for controlling an air-conditioning system.

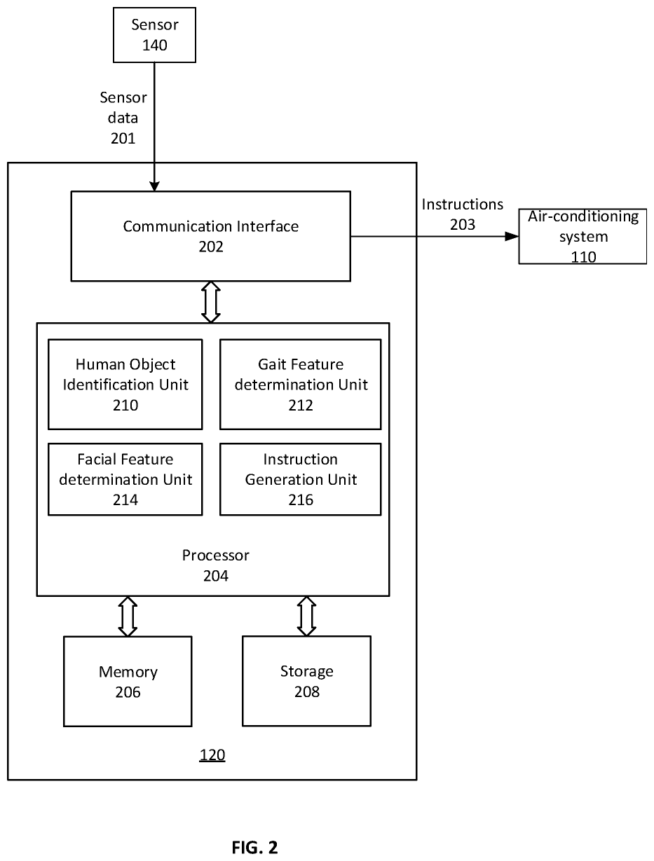

For example, FIG. 2 illustrates a block diagram of an exemplary controlling server 120 for controlling an air-conditioning system based on gait recognition, according to embodiments of the disclosure. Consistent with the present disclosure, controlling server 120 may use various types of sensor data 201 for air-conditioning system controlling. The various types of data may be captured by sensor 140 installed on an inner wall of a structure with respect to an inner space of the structure, such as a living room within a house. Sensor data 201 may include images or a video captured by sensor 140 consisting of multiple images of the inner space of the structure.

In some embodiments, as shown in FIG. 2, controlling server 120 may include a communication interface 202, a processor 204, a memory 206, and a storage 208. In some embodiments, controlling server 120 may have different modules in a single device, such as an integrated circuit (IC) chip (implemented as an application-specific integrated circuit (ASIC) or a field-programmable gate array (FPGA)), or separate devices with dedicated functions. In some embodiments, one or more components of controlling server 120 may be located inside air-conditioning system 110 or may be alternatively in a local or remote server, a mobile device, in the cloud, or another remote location. Components of controlling server 120 may be in an integrated device or distributed at different locations but communicate with each other through a network (not shown). For example, processor 204 may be a processor inside air-conditioning system 110, a processor inside a local or remote server, a processor inside a mobile device, or a cloud processor, or any combinations thereof.

Communication interface 202 may send data to and receive data from components such as sensor 140 or air-conditioning system 110 via, e.g., communication cables, a Wireless Local Area Network (WLAN), a Wide Area Network (WAN), wireless networks such as a radio wave network, a cellular network, and/or a local wireless network (e.g., Bluetooth™ or WiFi™), or other communication methods. In some embodiments, communication interface 202 can be an integrated services digital network (ISDN) card, a cable modem, a satellite modem, or a modem to provide a data communication connection. As another example, communication interface 202 can be a local area network (LAN) adaptor to provide a data communication connection to a compatible LAN. Wireless links can also be implemented by communication interface 202. In such an implementation, communication interface 202 can send and receive electrical, electromagnetic or optical signals that carry digital data streams representing various types of information.

Consistent with some embodiments, communication interface 202 may receive sensor data 201 captured by sensor 140. The received sensor data may be provided to memory 206 and/or storage 208 for storage or to processor 204 for processing. Communication interface 202 may also receive instructions generated by processor 204 and provide the instructions to any local component in air-conditioning system 110 or any remote device via a communication link.

Processor 204 may include any appropriate type of general-purpose or special-purpose microprocessor, digital signal processor, or microcontroller. Processor 204 may be configured as a separate processor module dedicated to controlling air-conditioning systems. Alternatively, processor 204 may be configured as a shared processor module that can also perform other functions unrelated to air-conditioning systems control.

As shown in FIG. 2, processor 204 may include multiple modules/units, such as a human object identification unit 210, a gait feature determination unit 212, a facial feature determination unit 214, an instruction generation unit 216, and the like. These modules/units (and any corresponding sub-modules or sub-units) can be hardware units (e.g., portions of an integrated circuit) of processor 204 designed for use with other components or to execute at least part of a program. The program may be stored on a computer-readable medium, and when executed by processor 204, it may perform one or more functions or operations. Although FIG. 2 shows units 210-216 all within one processor 204, it is contemplated that these units may be distributed among multiple processors located closely to or remotely from each other.

Human object identification unit 210 may be configured to identify human objects within sensor data 201. For example, human object identification unit 210 may identify human objects corresponding to users 131 and 132 within sensor data 201 based on background generation methods. For example, human object identification unit 210 may use the background generation method to identify human objects within the scene based on foreground detections, moving objects extractions, moving objects features extractions and moving object characterizations. For another example, machine learning methods may be applied to identify human objects. For example, a neural network (e.g., a convolutional neural network) may be pretrained using training sets (e.g., images having identified human objects) to process the images and to identify the human objects within the images.

Gait feature determination unit 212 may be configured to recognize gait features of the human objects. For example, gait feature determination unit 212 may extract a sequence of frames within sensor data 201 in which the human object is moving, and recognized the gait feature of the human object based on the extracted sequence of frames using any suitable model-based gait feature extraction method (e.g., methods based on activity specific static body parameters or methods based on thigh joint trajectories) where the human body structures or motions are modeled, or using any suitable model-free methods (e.g., methods based on template matching of body silhouettes in key frames during a human's walking cycle) where the entire human body motion is distinguished using a concise representation without considering the underlying body structure. Controlling server 120 may also use Hough Transformation-based gait recognition methods, Particle Filter based gait recognition methods and gait recognition methods based on support vector machines to recognize gait features of the identified human objects. In some embodiments, the recognized gait features include at least one of the identified human objects' ages, gender, location, velocity and pose information.

In some embodiments, gait feature determination unit 212 may further be configured to compare the recognized gait features with registered users' gait features. Based on the comparison, gait feature determination unit 212 may further identify that the human object corresponds to one of the registered users, such as user 131. For example, storage 208 may store preferences and gait features of different users (e.g., gait features of family members), and gait feature determination unit 212 may match the recognized gait features with the registered user's gait features (e.g., matching with the gait features of the family members respectively). If the human figure is determined to be one of the registered users (e.g., the recognized gait feature matches with the father's gait features), the human object may be identified as corresponding to the registered user (e.g., the father).

In some embodiments, facial feature determination unit 214 may be configured to recognize facial features of the identified human objects based on sensor data 201 captured by sensor 140. For example, facial feature determination unit 214 may use any suitable facial recognition methods such as anyone of the Active Shape Model (ASM), the Eigenface algorithm, the Convolutional Neural Network (CNN), etc. to identify the registered user. Facial feature determination unit 214 may identify that the human object corresponds to one of the registered users based on comparing the recognized gait features and the recognized facial features with the registered users' gait features and facial features.

Instruction generation unit 216 may be configured to generate instructions based on the recognized gait features. In some embodiments, instruction generation unit 216 may generate a first instruction including at least one of a target temperature, a target humidity, a target air flow volume and an air flow direction based on the recognized gait features. For example, instruction generation unit 216 may determine that one of the human objects identified within the scene is lying down in a location, instruction generation unit 216 may choose to modify the air flow to avoid blowing directly to the location and increase the target temperature to a level suitable for sleeping.

In some embodiments, instruction generation unit 216 may further be configured to generate a second instruction based on identifying that the human object corresponds to one of a registered user. For example, the second instruction may be generated based on the identified registered user's profile. In some embodiments, the human object is further identified to be corresponding to a registered user using a gait recognition model. In some other embodiments, the human object is further identified to be corresponding to a registered user using both a gait recognition model and a face recognition model. For example, instruction generation unit 216 may generated the second instruction based on identifying of the human object using a probability determined by a first prediction determined based on the face recognition model, a weight of the first prediction, a probability determined by the second prediction determined based on the gait recognition model, and a weight of the second prediction. In some embodiments, the weight may be pre-determined based on the precision of the face recognition model and the gait recognition model (e.g., the more precise the recognition model is, the heavier weight the recognition model will be assigned to).

As the controlling instruction generation process relies more heavily on user information captured by sensor 140 such as gait features and/or facial features than manual inputs by users, the controlling instruction better reflects the user's need while requiring less user interaction. Thus, the systems and methods disclosed herein improve the user experience.

Memory 206 and storage 208 may include any appropriate type of storage device provided to store any type of information that processor 204 may need to process. Memory 206 and storage 208 may be volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, and a static RAM. Memory 206 and/or storage 208 may be configured to store one or more computer programs that may be executed by processor 204 to perform air-conditioning system controlling functions disclosed herein. For example, memory 206 and/or storage 208 may be configured to store program(s) that may be executed by processor 204 to control air-conditioning system 110 to modify the air condition at the scene.

Memory 206 and/or storage 208 may be further configured to store information and data used by processor 204. For instance, memory 206 and/or storage 208 may be configured to store the various types of sensor data 201 captured by sensor 140, registered user profile and intermediary data generated by processor 204 such as identified human objects and recognized gait and/or facial features. The various types of data may be stored permanently, removed periodically, or disregarded immediately after each frame of data is processed.

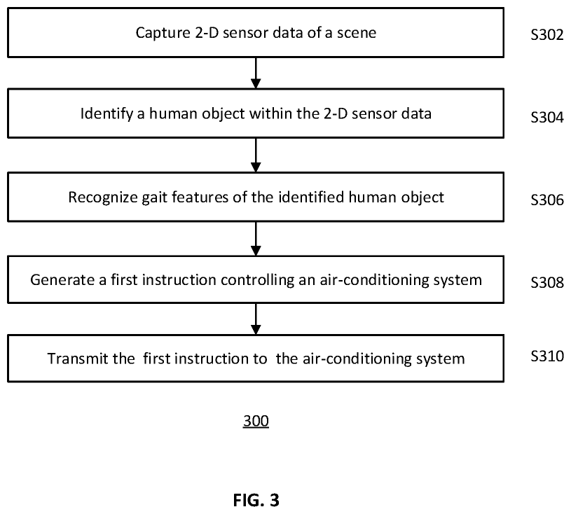

FIG. 3 illustrates a flowchart of an exemplary method 300 for controlling the air-conditioning system based on gait recognition, according to embodiments of the disclosure. For example, method 300 may be implemented by an air-conditioning controlling system 100 that includes, among other things, sensor 140 and controlling server 120 in communication with air-conditioning system 110. However, method 300 is not limited to that exemplary embodiment.

Method 300 may include steps S302-S310 as described below. It is to be appreciated that some of the steps may be optional to perform the disclosure provided herein. Further, some of the steps may be performed simultaneously, or in a different order than shown in FIG. 3.

In step S302, a sequence of image frames (e.g., sensor data 201) may be captured with respect to a scene. For example, sensor data 201 may be captured by sensor 140. In some embodiments, sensor data 201 may be sent to and received by controlling server 120. Sensor data 201 may be transmitted in real-time (e.g., by streaming), or collectively after a certain period of time (e.g., transmit images for every 5 seconds).

In step S304, controlling server 120 may identify human objects (e.g., human objects corresponding to users 131 and 132) within the scene using any suitable identification methods. For example, controlling server 120 may identify the human objects within the images based on background generation methods. For example, controlling server 120 may use background generation method to identify human objects within the scene based on foreground detections, moving objects extractions, moving objects features extractions and moving object characterizations. For another example, machine learning methods may be applied to identify human objects. For example, a neural network (e.g., a convolutional neural network) may be pretrained using training sets (e.g., images having human objects) to process the images and detect the human objects within the images.

In step S306, controlling server 120 may recognize gait features of the human objects. For example, controlling server 120 may extract a sequence of frames in which the human object is moving, and determine the gait features of the human object based on the extracted sequence of frames using any suitable model-based gait feature extraction methods (e.g., methods based on activity specific static body parameters or methods based on thigh joint trajectories) where the human body structures or motions are modeled, or using any suitable model-free methods (e.g., methods based on template matching of body silhouettes in key frames during a human's walking cycle) where the entire human body motion is distinguished using a concise representation without considering the underlying body structure. Controlling server 120 may also use Hough Transformation-based gait recognition methods, Particle Filter based gait recognition methods and gait recognition methods based on support vector machines to recognize gait features of the human objects. In some embodiments, the recognized gait features include at least one of the human objects' ages, position, velocity and pose information.

In step S308, controlling server 120 may generate a first instruction controlling air-conditioning system 110 based on the recognized gait features. In some embodiments, the first instruction includes at least one of a target temperature, a target humidity, a target air flow volume and a target air flow direction.

In step S310, controlling server 120 may transmit the first instruction (e.g., instructions 203) to air-conditioning system 110 to control the functioning of the system.

Based on the gait features of the occupants on the scene, the systems and methods disclosed herein can take into consideration user information while modifying the air condition. For example, the system may determine the age of the user and the status of the user (e.g., sleeping or working) and set a target temperature and/or target humidity suitable for the user. Also, the systems and methods disclosed herein can reduce the user interaction. For example, the systems and method disclosed herein do not require users to manually input parameters each time to improve the air condition.

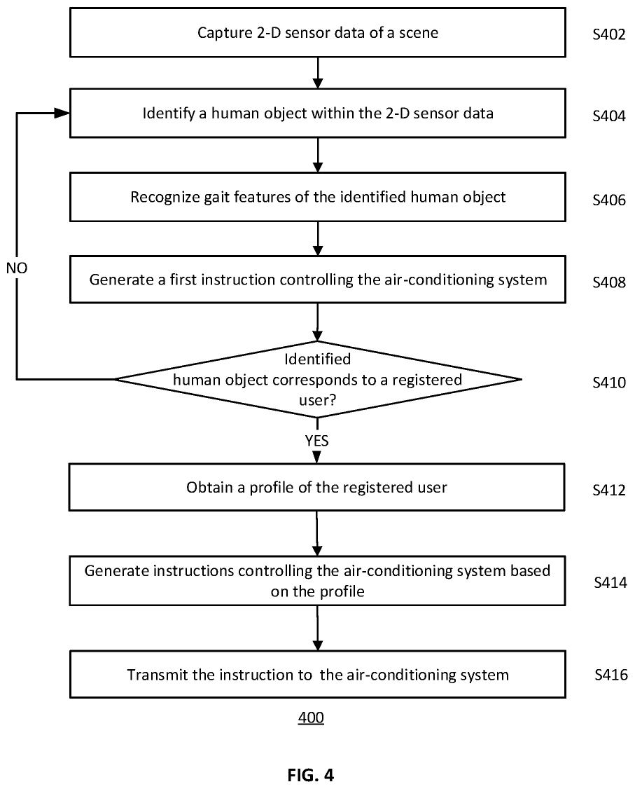

FIG. 4 illustrates a flowchart of another exemplary method 400 for controlling the air-conditioning system based on gait recognition, according to embodiments of the disclosure. Similar to method 300, method 400 may also be implemented by an air-conditioning controlling system 100 that includes, among other things, sensor 140 and controlling server 120 in communication with air-conditioning system 110. However, method 400 is not limited to that exemplary embodiment.

Method 400 may include steps S402-S408 that are substantially the same as steps S302-S308 in method 300 as described above which will not be repeated herein. Method 400 may also include steps S410-S416 as described below. It is to be appreciated that some of the steps may be optional to perform the disclosure provided herein. Further, some of the steps may be performed simultaneously, or in a different order than shown in FIG. 4.

In step S410, controlling server 120 may identify that the human object corresponds to a registered user. In some embodiments, controlling server 120 may compare the recognized gait features with the registered users' gait features. Controlling server 120 may identify the human object to be corresponding to one of the registered users. For example, controlling server 120 may store preferences and gait features of different users (e.g., gait features of family members), and matching the recognized gait features with the registered user's gait features (e.g., matching with the gait features of the family members respectively). If the identified human figure is identified to be corresponding to one of the registered users, e.g., the recognized gait feature matched with the father's gait features, controlling server 120 may identify that the human object corresponds to the registered user, e.g., the father (S410: yes). Otherwise (S410: no), method 400 may return to step S404 and identify another human object within the scene.

In some other embodiments, as part of step S410, controlling server 120 may further recognize facial features of the human object based on the images captured by sensor 140. For example, controlling server 120 may use any suitable facial recognition methods such as any one of the Active Shape Model (ASM), the Eigenface algorithm, the Convolutional Neural Network (CNN), etc. Controlling server 120 may compare the recognized gait features along with the recognized facial features to the registered users' gait features and facial features.

Based on the comparison, controlling server 120 may determine the human object to be corresponding to one of the registered. For example, controlling server 120 may generate a first prediction of an identity of the human object based on a face recognition model, and may also generate a second prediction of the identity of the human object based on a gait recognition model. Controlling server 120 may further determine the identity of the human object based on a probability determined by the first prediction, a weight of the first prediction, a probability determined by the second prediction, and a weight of the second prediction. For example, the weight may be pre-determined based on the precision of the face recognition model and the gait recognition model (e.g., the more precise the recognition model is, the heavier weight the recognition model will be attached to).

In step S412, controlling server 120 may obtain a profile (e.g., the registered user's pre-set preference) of the registered user and may generate instructions controlling the air-conditioning system based on the user profile in step S414. In some embodiments, controlling server 120 may generate a second instruction based on the identified registered user's profile. For example, if the human object is identified to be corresponding to the father's profile, controlling server 120 may generate the second instruction based on the father's profile regarding the father's pre-set preference.

In some embodiments, controlling server 120 may generate the second instruction based on prioritizing the registers' preference (e.g., give the older user a higher priority than the younger user), or weighting the registers' preference (give the older user more weight than the younger user) if more than one registered user is identified.

In some other embodiments, controlling server 120 may generate a third instruction based on the first and the second instruction to control air-conditioning system 110. For example, controlling server 120 may prioritize different instructions based on the operation mode the instruction corresponds to. For example, controlling server 120 may generate a first instruction suitable for sleeping based on identifying a sleeping human objects on the scene and controlling server 120 may also generate a second instruction not suitable for sleeping based on a registered user's profile. Controlling server 120 may generate a third instruction based on the first instruction and the second instruction by giving the first instruction a heavier weight (e.g., 60% weight) and the second instruction a lesser weight (e.g., 40% weight).

In step S416, controlling server 120 may transmit the instruction (e.g., instructions 203) to air-conditioning system 110 to control the functioning of the air conditioning system. In some embodiments, the first instruction may be transmitted if no registered user is identified (e.g., no registered user's profile matches the human object's gait features and/or facial features). In some embodiments, the second instruction may be transmitted if one or more registered users are identified on the scene. In some other embodiments, the third instruction may be transmitted if there are more than one human objects that cannot be identified as registered users or if the identified user's gait features call for a different instruction than the one generated based on the user's profile (e.g., the first instruction generated to accommodate a current status of a registered user is different from the second instruction generated according to registered user's normal preference).

Based on identifying the registered users at the scene, the systems and methods disclosed herein can take into consideration user information while modifying the air condition. Also, the systems and methods disclosed herein can reduce user interactions. For example, the systems and methods disclosed herein do not require users to manually input parameters each time to improve the air condition. The user may only need to complete his profile once and the systems and methods disclosed herein can generate instructions to control the air-conditioning system based on the profile whenever it detects the user presents at the scene.

Another aspect of the disclosure is directed to a non-transitory computer-readable medium storing instruction which, when executed, cause one or more processors to perform the methods, as discussed above. The computer-readable medium may be volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A method for controlling an air-conditioning system based on gait recognition, comprising:
receiving sensor data captured of a scene by a sensor;
identifying, by at least one processor, a human object within the sensor data;
recognizing a plurality of gait features of an identified human object; and
generating a first instruction controlling the air-conditioning system based on a plurality of recognized gait features.

2. The method of claim 1, wherein the plurality of gait features comprise at least one of age, gender, position, speed and pose information of the identified human object.

3. The method of claim 1, further comprising:
determining the identified human object as corresponding to one of a plurality of registered users based on the plurality of recognized gait features; and
generating a second instruction controlling the air-conditioning system based on a profile of the plurality of registered users.

4. The method of claim 3, wherein the profile of the plurality of registered users comprises the plurality of gait features of the plurality of registered users, and wherein determining the identified human object as corresponding to one of the plurality of registered users further comprises matching the plurality of recognized gait features with the plurality of gait features of the plurality of registered users.

5. The method of claim 3, further comprising generating a third instruction controlling the air-conditioning system based on the first instruction and the second instruction.

6. The method of claim 3, further comprising:
recognizing a plurality of facial features from the identified human object; and
determining the identified human object as corresponding to one of the plurality of registered users based on both the plurality of recognized gait features and a plurality of recognized facial features.

7. The method of claim 6, wherein determining the identified human object as corresponding to one of the plurality of registered users further comprises:
generating a first prediction of an identity of the identified human object based on a face recognition model;
generating a second prediction of the identity of the identified human object based on a gait recognition model; and
determining the identity of the identified human object based on a probability determined by the first prediction, a weight of the first prediction, a probability determined by the second prediction, and a weight of the second prediction.

8. The method of claim 6, further comprising determining the identified human object as corresponding to one of the plurality of registered users using a model trained based on the plurality of gait features and the plurality of facial features of the plurality of registered users.

9. The method of claim 3, wherein when more than one registered users of the plurality of registered users are identified within the scene, the second instruction is generated based on a priority among the more than one registered users of the plurality of registered users.

10. The method of claim 1, wherein the first instruction controls at least one of a target temperature, a target humidity, a target exhaust amount and a target blow direction.

11. A system for controlling an air-conditioning system based on gait recognition, comprising:
a communication interface configured to receive sensor data captured of a scene by a sensor;
a storage configured to store the sensor data and a profile of a plurality of registered users; and
at least one processor configured to:
identify a human object within the sensor data;
recognize a plurality of gait features of an identified human object; and
generate a first instruction controlling the air-conditioning system based on a plurality of recognized gait features.

12. The system of claim 11, wherein the plurality of gait features comprise at least one of age, gender, position, speed and pose information of the identified human object.

13. The system of claim 11, wherein the at least one processor is further configured to:
determine the identified human object as corresponding to one of the plurality of registered users based on the plurality of recognized gait features; and
generate a second instruction controlling the air-conditioning system based on a profile of the plurality of registered users.

14. The system of claim 13, wherein the profile of the plurality of registered users comprises the plurality of gait features of the plurality of registered users, and wherein to determine the identified human object as corresponding to one of the plurality of registered users, the at least one processor is further configured to match the plurality of recognized gait features with the plurality of gait features of the plurality of registered users.

15. The system of claim 13, wherein the at least one processor is further configured to generate a third instruction controlling the air-conditioning system based on the first instruction and the second instruction.

16. The system of claim 13, wherein the at least one processor is further configured to:
recognize a plurality of facial features of the identified human object; and
determine the identified human object as corresponding to one of the plurality of registered users based on both the plurality of recognized gait features and the plurality of recognized facial features.

17. The system of claim 16, to determine the identified human object as corresponding to one of the plurality of registered users, the at least one processor is further configured to:
generate a first prediction of an identity of the identified human object based on a face recognition model;
generate a second prediction of the identity of the identified human object based on a gait recognition model; and
determine the identity of the identified human object based on a probability determined by the first prediction, a weight of the first prediction, a probability determined by the second prediction and a weight of the second prediction.

18. The system of claim 16, wherein the at least one processor is further configured to determine the identified human object as corresponding to one of the plurality of registered users using a model trained based on the plurality of gait features and the plurality of facial features of the plurality of registered users.

19. A non-transitory computer-readable medium having instructions stored on the non-transitory computer-readable medium, wherein when executed by one or more processors, causes the one or more processors to perform a method for controlling an air-conditioning system based on gait recognition comprising:
receiving sensor data captured of a scene by a sensor;
identifying a human object within the sensor data;
recognizing a plurality of gait features of an identified human object; and
generating a first instruction controlling the air-conditioning system based on a plurality of recognized gait features.

20. The computer-readable medium of claim 19, wherein the method performed by the one or more processors further comprises:
determining the identified human object as corresponding to one of a plurality of registered users based on the plurality of recognized gait features; and
generating a second instruction controlling the air-conditioning system based on a profile of the plurality of registered users.
